(19) United States
(12) Patent Application Publication
(10) Pub. No.: US 2008/0190631 A1
(43) Pub. Date: Aug. 14, 2008

(54) Vibration Reduction in Electric Tools

(76) Inventors: Joerg Lemmel, Weinstadt (DE); Klaus Kuespert, Leinfelden-Echterdingen (DE)

Correspondence Address: MICHAEL J. STRIKER, 103 EAST NECK ROAD, HUNTINGTON, NY, 11743, US

(21) Appl. No.: 11/909,999

(22) PCT Filed: Nov. 16, 2006
(86) PCT No.: PCT/EP06/68583

§ 371 Date: Sep. 28, 2007

(30) Foreign Application Priority Data
Dec. 29, 2005 (DE) 102005062883.4

(51) Int. Cl. B25F 5/00

(52) U.S. Cl. 173/162.1; 173/162.2

(57) ABSTRACT

The invention relates to an electric tool, in particular a portable electric tool, which has at least one vibration reduction device. Provision is made for the vibration reduction device 5, 6, 7, 8, 9 to comprise at least one additional mass 15. Furthermore, the invention includes a vibration reduction device 5, 6, 7, 8, 9 which is designed for use with an electric tool.

The invention relates to an electric tool having the characteristics recited in the preamble to claim 1.

### PRIOR ART

Electric tools, especially handheld electric tools, such as right-angle sanders, linear sanders, surface milling cutters, chainsaws, reciprocating sanders, drill hammers, drilling machines, or eccentric sanders, cause strong hand and arm vibration, which can cause disorders such as Raynaud's syndrome.

Various methods and devices are known for vibration reduction in handheld electric tools. For instance, it is known to use vibration-damped supplementary handles, which make use of the principle of mass-spring damping, for instance using rubber dampers, quenching masses, or supplementary masses.

For instance, from German Patent Disclosure DE 103 48 976 A1, a vibration-damped handle is known in which the handle is embodied as a bush in the interior of which a quenching mass is supported in such a way that it is capable of vibration. The quenching mass is made from steel, while for attaching the quenching mass in the hollow space in the bush, retaining means are employed that are made from an elastomer material.

### ADVANTAGES OF THE INVENTION

The device of the invention having the characteristics recited in claim 1 offers the advantage over the prior art that because the vibration-reducing device includes at least one supplementary mass, an increase in the mass moment of inertia can be attained. This reduces wobbling motions, especially three-dimensional wobbling motions of the electric tool, in use. Moreover, vibration is reduced not only at a main handle but at supplemental handles as well.

In a preferred embodiment, it is provided that the supplementary mass is joined to the electric tool by means of a spacer element. The spacer element, which may be embodied as a handle, assures that the supplementary mass is located at a maximum distance from the electric tool, which enhances the vibration-damping effect of the at least one supplementary mass.

Moreover, in a preferred embodiment, it is provided that the vibration-reducing device can be secured rigidly to the electric tool; that is, no vibration-damping elements, for instance, are used.

In a further embodiment, it is also provided that the vibration-reducing device is embodied rigidly. For instance, no damping rubber elements or other damping elements are provided in the vibration-reducing device. Moreover, no vibration-damping quenching masses are provided, either.

In a preferred embodiment, it is provided that the spacer element is embodied as a handle. Thus a supplementary handle can be formed at the same time.

In a preferred embodiment, it is provided that a first end is provided with a securing means for releasable securing to an electric tool, and the supplementary mass is located on a second end of the spacer element.

It is preferably provided that the securing means is a thread, a bayonet mount, a click closure, or a twist lock. Thus the spacer element can be disconnected from the electric tool and replaced, while the location of the supplementary mass on the second end assures that the supplementary mass is located at a maximum distance from the electric tool.

It is furthermore preferably provided that the supplementary mass is embodied by a rechargeable battery. Suitable contacts on the first end of the spacer element make it possible to supply electrical energy to an electric tool.

In a preferred embodiment, the electric tool is a right-angle sander. However, it may also be a linear sander, a surface milling cutter, a chainsaw, a reciprocating sander, a drill hammer, a drilling machine, or an eccentric sander.

In a further embodiment, it is provided that the at least one supplementary mass is located on a guard hood of the electric tool, in particular of a right-angle sander. Locating the at least one supplementary mass in this way assures a maximum distance of the supplementary mass from the electric tool, or from a tilt axis of the electric tool, since the guard hood includes the points that are farthest away from the tilt axis.

The at least one supplementary mass may be secured to the guard hood. To that end, a supplementary ring may preferably form a supplementary mass and the supplementary ring can be slipped on, or preferably, supplementary masses are secured individually, for instance by means of screw connections.

However, in a preferred embodiment, it is provided that the at least one supplementary mass is integrated with the guard hood. This kind of one-piece embodiment of the supplementary mass can preferably be formed by a thickened edge, or a bent-over or crimped-over sheet-metal edge.

A vibration-reducing device, embodied for use with an electric tool, is also part of the invention.

### DRAWINGS

The invention will be described in further detail below in terms of an exemplary embodiment in conjunction with the drawings.

FIG. 1 is a plan view on a right-angle sander according to the invention, having a plurality of vibration-reducing devices according to the invention; and

FIG. 2 is a schematic view of a vibration-reducing device according to the invention.

### DESCRIPTION OF THE EXEMPLARY EMBODIMENT

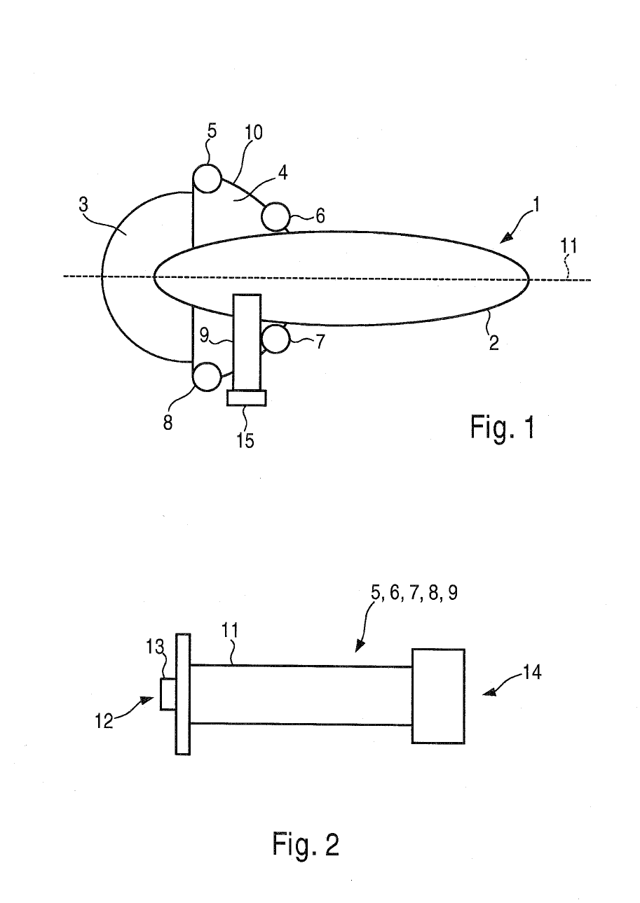

In FIG. 1, a right-angle sander 1 is shown as an example of a handheld electric tool. The right-angle sander 1 has a basic body 2, in the interior of which a motor (not shown) for driving a sanding wheel 3 is located. A rotatable guard hood 4 is also secured to the basic body 2; it partly covers the sanding wheel 3 of the right-angle sander 1 and thus makes tool operation safer.

The right-angle sander 1, in the exemplary embodiment shown in FIG. 1, is provided with five vibration-reducing devices 5, 6, 7, 8, 9. However, it is possible for each of the five vibration-reducing devices 5, 6, 7, 8, 9 to be employed alone or in arbitrary combination with one another. In FIG. 1, four vibration-reducing devices 5, 6, 7, 8 are secured to the guard hood 10, while the fifth vibration-reducing device 9 is embodied as a handle and is secured to the basic body 2 of the right-angle sander 1. However, the vibration-reducing device 9 embodied as a handle may also be located at other positions than that shown in FIG. 1.

Four vibration-reducing devices 4, 5, 6, 7 are located on the outer radius of the guard hood 10; in the position of the guard hood in FIG. 1, the vibration-reducing devices 5, 8 are at the greatest distance from the right-angle sander 1 or basic body 2 of the right-angle sander 1.

The vibration-reducing device 5, 6, 7, 8, 9 shown in FIG. 2 comprises a spacer element 11, embodied as a handle, with a substantially bushlike or cylindrical basic shape.

Located on a first end 12 of the spacer element 11 is a thread 13, with which the vibration-reducing device 5, 6, 7, 8, 9 can be releasably secured to a right-angle sander 1, or some other electric tool, such as a linear sander, a surface milling cutter, a chainsaw, a reciprocating sander, or a drill hammer.

A supplementary mass 15 is located on a second end 14 of the spacer element 11. In the present exemplary embodiment, the supplementary mass 15 is formed by a rechargeable battery, and suitable contacts (not shown) on the first end 12 of the spacer element 11 permit supplying electrical energy to an electric tool, when the vibration-reducing device 5, 6, 7, 8, 9 is connected to a right-angle sander 1 or some other handheld electric tool.

The thread 13 on the first end 12 of the spacer element 11 permits a rigid, or in other words essentially not vibration-damping, fastening of the device to a right-angle sander 1 or some other handheld electric tool. The vibration-reducing device 5, 6, 7, 8, 9 has no damping rubber elements. The spacer element 11 assures that the supplementary mass 15, with a spacing distance corresponding to the length of the spacer element 11, is located as far away as possible from a right-angle sander 1 or some other handheld electric tool when the vibration-reducing device 5, 6, 7, 8, 9 is connected to a right-angle sander 1 or some other handheld electric tool.

As a result of the location of vibration-reducing devices 5, 6, 7, 8 on the guard hood 4 and the location of the fifth vibration-reducing device 9 on the basic body 2, it is attained that the five vibration-reducing devices 5, 6, 7, 8, 9 are at a maximum distance from the right-angle sander 1, or from a tilt axis 11 of the right-angle sander 1 that extends through the basic body 2 of the right-angle sander 1.

Hence an increase in the mass moment of inertia of the right-angle sander 1 is attained, and wobbling motions of the right-angle sander 1 in use are reduced. In particular, three-dimensional wobbling motions, which are brought about by imbalances of the sanding wheel 3 and centrifugal motions of the motor (not shown), are greatly reduced.

1. An electric tool, in particular a handheld electric tool, which has at least one vibration-reducing device, characterized in that the vibration-reducing device (5, 6, 7, 8, 9) includes at least one supplementary mass (15).

2. The electric tool as defined by claim 1, characterized in that the supplementary mass (15) is joined to the electric tool (1) by means of a spacer element (11).

3. The electric tool as defined by claim 1, characterized in that the vibration-reducing device (5, 6, 7, 8, 9) can be secured rigidly to the electric tool (1).

4. The electric tool as defined by claim 1, characterized in that the vibration-reducing device (5, 6, 7, 8, 9) is embodied rigidly.

5. The electric tool as defined by claim 1, characterized in that the spacer element (11) is embodied as a handle.

6. The electric tool as defined by claim 1, characterized in that the spacer element (11) is provided on a first end (12) with a securing means for releasable securing to an electric tool, and the supplementary mass (15) is located on a second end (14) of the spacer element (11).

7. The electric tool as defined by claim 6, characterized in that the securing means is a thread (13), a bayonet mount, a click closure, or a twist lock.

8. The electric tool as defined by claim 1, characterized in that the supplementary mass (15) is embodied by a rechargeable battery.

9. The electric tool as defined by claim 1, characterized in that the electric tool (1) is a right-angle sander, a linear sander, a surface milling cutter, a chainsaw, a reciprocating sander, a drill hammer, a drilling machine, or an eccentric sander.

10. The electric tool as defined by one claim 1, characterized in that the at least one supplementary mass (15) is located on a guard hood (4) of the electric tool (1), in particular of a right-angle sander.

11. The electric tool as defined by claim 10, characterized in that the at least one supplementary mass (15) is secured to the guard hood (4).

12. The electric tool as defined by claim 11, characterized in that a supplementary ring forms the supplementary mass, and the supplementary ring is slipped on.

13. The electric tool as defined by claim 1, characterized in that supplementary masses are secured individually.

14. The electric tool as defined by claim 10, characterized in that the at least one supplementary mass (15) is integrated with the guard hood (4).

15. The electric tool as defined by claim 14, characterized in that the supplementary mass is formed by a thickened edge, or a bent-over or crimped-over sheet-metal edge.

16. A vibration-reducing device, embodied for use with an electric tool as defined by claim 1.
